(19) United States
(12) Patent Application Publication
(10) Pub. No.: US 2009/0123224 A1
(43) Pub. Date: May 14, 2009

(54) METHOD FOR ASSEMBLING A FATIGUE-RESISTANT MECHANICAL JOINT

(75) Inventor: Francis Dazet, Tounous Darre (FR)

Correspondence Address: PERMAN & GREEN, 425 POST ROAD, FAIRFIELD, CT, 06824, US

(73) Assignee: Airbus France, Toulouse Cedex 9 (FR)

(21) Appl. No.: 12/248,999

(22) Filed: Oct. 10, 2008

(30) Foreign Application Priority Data
Oct. 11, 2007 (FR) 0758220

(51) Int. Cl. F16C 11/06; B23P 11/00

(52) U.S. Cl. 403/143; 29/898

(57) ABSTRACT

A method for assembling two non-integral elements to form an articulated mechanical joint, a first element including, at the joint, an end piece including two yokes, a second element including, at the joint, a yoke, the method including at least one step for drilling bores in the yokes of each element, and one step for the snug fit assembly of rings or ball joints on inner surfaces of yokes of the two elements. An additional step of shot-peening of the inner surfaces of the bores of the yokes of the two elements is carried out, for each bore, between the step of drilling bores and the step of interference mounting of the ring or of the ball joint.

### BACKGROUND

1. Field

The present invention belongs to the field of articulated mechanical joints used for connecting together fixed or movable elements and allowing the mounting and dismounting of said elements. More particularly, the invention relates to a method for assembling elements through an articulated joint when said articulated joint is very often operated with alternate efforts causing fatigue phenomena.

2. Brief Description of Related Developments

Articulated mechanical joints, such as for example control linkages or certain structural connection rods, are more particularly used aboard vehicles for transmitting efforts and are generally submitted to alternate forces loadings.

A mechanical joint includes for example, as illustrated in FIG. 1, a first element 1, such as for example a connecting rod or a bell crank, only one end piece of which is shown, held to a second element 2, such as for example a lever or another connecting rod, by a pivot shaft 3. The first element includes an end piece provided with two yokes 11, which are substantially parallel to each other. The gap between the two yokes 11 of the first element 1 accommodates a yoke 21 of the second element 2. The yokes 11 of said first element 1, respectively, the yoke 21 of said second element 2, includes a bore 13, respectively 23. The bores 13 and 23 are coaxial and are crossed by the pivot shaft 3.

This type of articulated mechanical joint was found vulnerable as regards the bores 13, 23 of the yokes 11, 21 of the two elements 1, 2, mainly because of the high and alternate loads leading to fatigue phenomena.

In order to improve the fatigue resistance of such a joint, a known solution consists in a snug fit assembly of a ring 31 and/or a ball joint 32 on inner surfaces 14, 24 of the bores 13, 23 of the yokes 11, 21 of the two elements 1, 2 in order to introduce a compressive preload in the yokes, as illustrated in FIG. 1.

A snug fit assembly corresponds to the mounting of a ring in a bore of a yoke having a diameter substantially smaller than that of said ring. One embodiment consists in mounting the ring in the bore of the yoke, for example by means of a thermal sinking method. Such method consists in strongly cooling the ring with liquid nitrogen, with the temporary sinking of the ring allows it to be introduced with some clearance into the bore of the yoke. When the ring expands, which is the consequence of the gradual return to the room temperature thereof, the surfaces contacting the ring and the bore of the yoke are compressed, and a blocking corresponding to the expected tightening is obtained.

The snug fit assembly thus makes it possible to create compressive stresses in the material about the bore and increases the fatigue life of the metallic materials used.

However, although such solution brings an improvement in the fatigue resistance of the yokes through the introduction of a preload with a ring, it is limited by the necessity of being able to shaft the ring, which limits the efficiency of the preload.

In order to withstand higher loads, a solution consists in increasing the thickness of the yokes. However, this increased thickness cannot always be obtained because of a relatively constraining existing environment.

In addition, in order to facilitate the installation of the rings, it is known to provide the bores of the yokes with chamfers. Such chamfers are mandatory in order to perform the assembly when the fitting is very tight. However, the snug fit assembly does not set up a compressive preload in the yoke material in the area of the yoke corresponding, in thickness, to the area of the yoke comprising the chamfer.

Another drawback is related to the sensitivity of such articulated joints to corrosion. In this case, a solution consists in adding a surface treatment, which provides a protection against corrosion. Such a treatment may be carried out, for example, for aluminium alloys using a chromic anodic oxidizing method or a tartric sulphuric acid anodizing (TSA) method including prior degreasing and pickling steps.

Such surface treatment renders the various elements of the articulated joint more resistant to corrosion. However, such a corrosion protection against corrosion reduces the fatigue resistance of the articulated joint by a high percentage in the order of 30%, with respect to an articulated joint which does not have such a protection.

### SUMMARY

The method according to the invention, for assembling two non-integral elements in order to form an articulated mechanical joint, comprises,

a first element including, at said articulated mechanical joint, an end piece including at least one yoke made of a metallic material,

a second element including, at said articulated mechanical joint, an end piece including at least one yoke made of a metallic material,

said method including the following steps:

a) the drilling of bores:

a1) in the yoke or yokes of the first element, according to nominal dimensions for mounting one ring or rings,

a2) in the yoke or yokes of the second element according to nominal dimensions for mounting one ball joint or ball joints,

b) the snug fit assembly:

b1) of one ring or rings on an inner surface of the bore of the yoke or yokes of the first element,

b2) of one ball joint or ball joints on an inner surface of the bore of the yoke or yokes of the second element,

c) the positioning of the at least two elements of the articulated joint so that the bores of said two elements are coaxial,

d) the mounting of a pivot shaft in the ring and the ball joint of the bores, so that said pivot shaft holds together the at least two previously positioned elements.

The method further includes at least one additional step of shot-peening the inner surfaces of the bores of the yokes of the two elements, so as to create compressive stresses on said inner surfaces of the bores of the yokes of said two elements, said additional step of shot-peening being carried out, for each bore, between the step of drilling the bore and the step of the snug fit assembly of the ring or of the ball joint.

Such a shot-peening process differs from shot blasting or grit blasting processes that aim primarily at cleaning the surface or changing its roughness parameters. According to the invention the shot peening aims at introducing compressive residual stresses deeply under the shot peened surface. A typical depth is comprised between 0.05 and 0.2 mm or more.

Advantageously, during the additional step of shot-peening, a shot-peening is carried out on surfaces of chamfers when the bores of the yokes include one chamfer or chamfers.

In one embodiment of the method, the shot-peening of the inner surfaces of bores is carried out using an oscillating shot-peening nozzle, radially projecting shots, and positioned inside said bores.

In another embodiment of the method, a shot-peening of the inner surfaces of the bores is carried out by a deflector, axially projecting shots, and positioned inside said bores.

In order to restore the diameter of the bores to the nominal dimension for the mounting, a reboring of the bore can be carried out after the shot-peening step.

In addition, corrosion protective surface treatments may be carried out after the reboring of the bore.

The invention also relates to a mechanical joint which includes:

a first element including at least one yoke, made of a metallic material,

a second element including at least one yoke, made of a metallic material,

the yokes of each element including each a bore, said bores being coaxial such as to allow the insertion of the pivot shaft in order to assemble the two elements. The material of the yokes close to the inner surfaces of said bores is pre-stressed independently of the snug fit assembly of the ring and/or the ball joint in said bores.

The material is pre-stressed because of the shot-peening of the inner surfaces of the bores.

The detailed description of the invention is made while referring to the figures, wherein:

### BRIEF DESCRIPTION OF THE DRAWINGS

FIG. 1, already mentioned, is a cross-sectional view of the elements showing an exemplary articulated joint,

FIG. 2, is a perspective view of the elements intended to form an articulated joint, prior to the application of the method, according to the invention,

FIG. 3, is a perspective view illustrating the drilling of the bores into the two elements intended to form an articulated joint during the first step of the method according to the invention,

FIG. 4, is a perspective view illustrating an exemplary shot-peening of the surface of a bore, during a second step of the method according to the invention,

FIG. 5, is a cross-sectional view illustrating the positioning of the rings and ball joint into the elements, during the third step of the method according to the invention,

FIG. 6, is a top view illustrating an exemplary positioning of the elements, during the fourth step of the method according to the invention,

FIG. 7, is a cross-sectional view of the elements embodying an exemplary articulated joint, after the assembly, according to the invention.

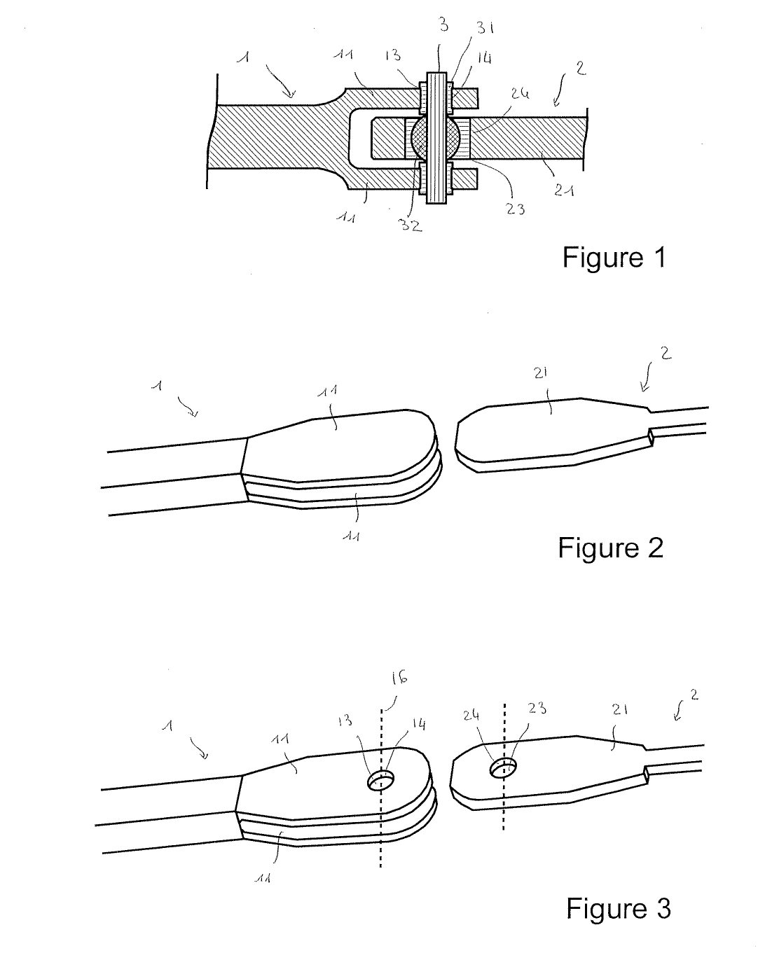

The object of the method is the assembling of two metallic elements of an articulated mechanical joint submitted to high levels of charge.

The exemplary embodiment of the method is described in the application thereof in the case of a control linkage, for example between an actuator and a movable element of an aircraft. This choice is not limitative and the method can also be applied to any assembly including an articulated joint.

### DETAILED DESCRIPTION OF THE DRAWINGS

In this application, the articulated joint, as illustrated in FIG. 2, includes a first element 1, such as for example, a first connecting rod or a bell crank, including an end piece including two yokes 11 which are substantially parallel to each other. A second element 2, such as for example a lever or a second connecting rod, includes an end piece including a yoke 21. The yoke 21 has a thickness such that said yoke can be inserted into the gap between the two yokes 11 of said first element.

Other articulated joints can also be made from the method according to the invention, wherein each element includes one yoke or several yokes, without leaving the scope of the invention.

In order to make the articulated joint according to the method, in a first step, as illustrated in FIG. 3, through bores 13, 23 are drilled in each yoke 11, 21 of each element 1, 2 so that said bores have the same nominal dimensions for the assembly and as a function of the subsequent tightening type desired.

The bores 13 of the yokes 11 of the first element 1 are drilled so that said bores have the same axis 16.

In a second step, a shot-peening operation is carried out on inner surfaces 14, 24 of the bores 13, 23 of the yokes 11, 21 of the two elements.

The shot-peening results in the introduction of deformations on the inner surfaces of the bores of the yokes in order to produce superficial compressive stresses.

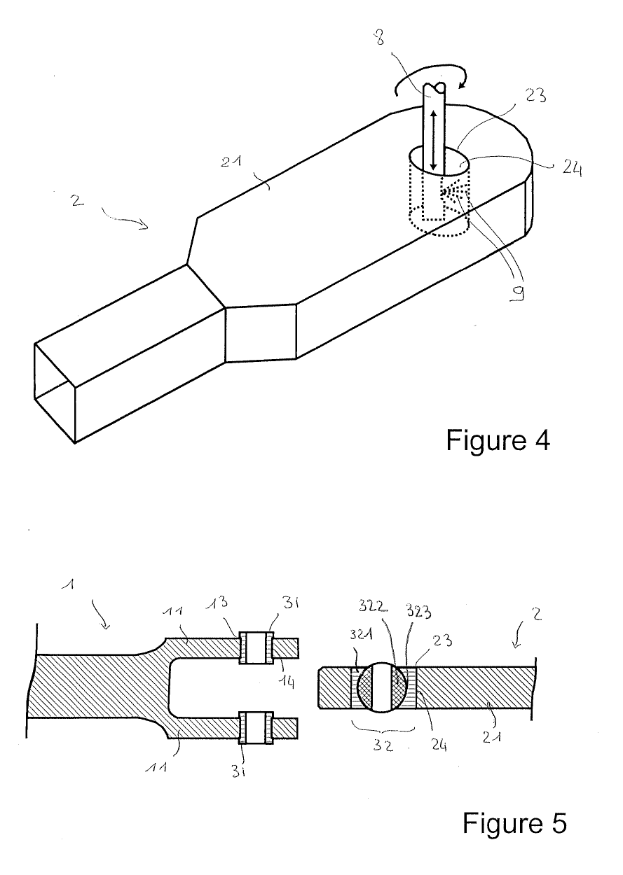

An embodiment of the second step of the method consists, for example, in high-speed projecting substantially spherical balls, also called shots, onto the inner surfaces of the bores of the yokes. Means for carrying out such operation consist, for example, in positioning an oscillating nozzle 8, inside the bore 23 of the yoke 21 of the element 2, as illustrated in FIG. 4, (and similarly inside the bores 13 of the two yokes 11 of the element 1) which projects, at a determined radial speed, and for example by means of an air jet, shots 9 onto the inner surface 24 of the bore 23. Other means consist in placing a shot deflector, inside the bore 23 of the yoke 21 of the element 2 (and similarly inside the bores 13 of the two yokes 11 of the element 1) which projects shots 9, at a determined axial speed, and for example using an air jet, onto the inner surface 24 of the bore 23. Such method is advantageously embodied in the case where the bore has a depth greater than the diameter of said bore.

In one embodiment, when the bores 13, 23 of the yokes 11, 21 include, preferably, a chamfer (not shown) in order to facilitate the subsequent positioning of a pivot shaft in the bores, the shot peening operation is advantageously extended to said chamfer.

Shot-peening makes it possible to set up a compressive preload through the whole thickness of the yokes, including in the chamfer.

Preferably, in order to increase the efficiency of the shot-peening, a degreasing operation is previously carried out on the surfaces 14, 24 of the bores 13, 23 to be shot-peened, prior to the projection of shots 9.

During the shot-peening operation, the dimensions of the bores may be modified and their diameter may be reduced. However, as the shot-peening has a relatively deep effect, the bore may be drilled again after the shot-peening operation to restore the diameter of the bore to the mounting dimension, without wasting the shot-peening operation, i.e. the pre-tension. The shot-peening operation is also compatible with the respect of the initial assembly tolerances.

The shot-peening operation is compatible with subsequent treatments against corrosion such as, for example, treatments using a chromic anodic oxidizing method or a tartric sulphuric acid anodizing (TSA) method, which do not affect the advantage of the shot-peening operation. Such anti-corrosion treatments are carried out after the drilling of the bore.

Upon completion of such second step, the resistance to fatigue and the resistance of the yokes to corrosion under stress are improved because of the shot-peening operation.

In a third step of the method, as illustrated in FIG. 5, rings 31 and/or ball joints 32 are snug fit assembled into the bores 13 and 23.

A ring 31 is snug fit assembled in the inner surface 14 of each yoke 11 of the first element 1 and a ball joint 32 is snug fit assembled in the inner surface 24 of the yoke 21 of the second element 2.

The rings 31 have a substantially annular shape, with an external diameter which is substantially greater than the diameter of the bore 13 in order to provide the snug fit assembly of said rings.

The ball joint 32 has a substantially annular external shape, having an external diameter which is substantially greater than the diameter of the bore 23 and having an inner diameter which is substantially equal to the inner diameter of the rings, so as to allow the insertion of a pivot shaft. Said ball joint includes an external ring, also called a cage 321, and an internal ring, called a nut 322, cooperating through spherical contact surfaces 323.

In one embodiment, the ring 31 (and similarly the ball joint 32) is mounted using a thermal sinking method of said ring. Means consist in strongly and temporarily cooling the ring, for example with liquid nitrogen, the temporary sinking of the ring enabling the introduction of the ring into the bore 13 of the yoke 11 of the first element 1 with some clearance.

Upon completion of such third step, an additional preload is applied onto the inner surfaces of the bores.

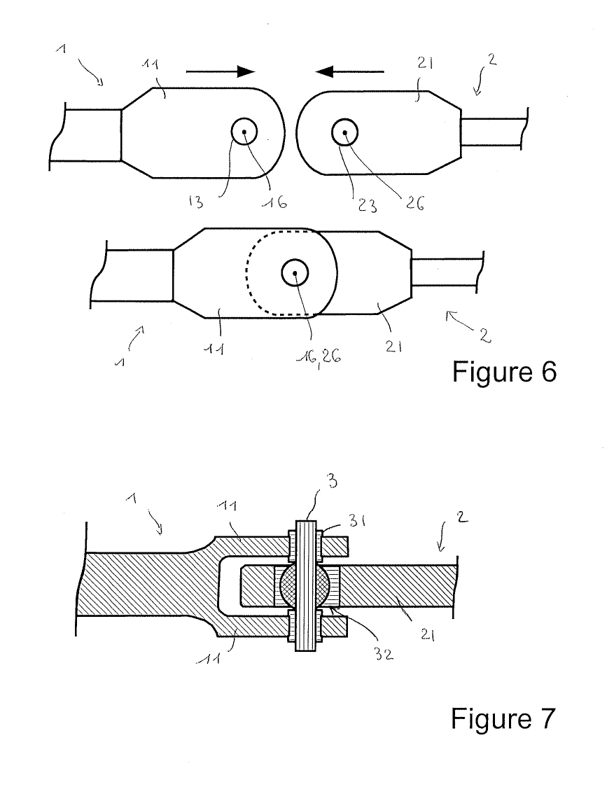

In a fourth step of the method, the yokes 11 of the first element 1 and the yoke 21 of the second element 2 are held in a position corresponding to a relative position in an assembly of the articulated joint, for example, as illustrated in FIG. 6, as an extension to each other.

The bores of the yokes of the two elements are aligned so that the axis 16 of the bores 13 of the yoke 11 of the first element are substantially superimposed with an axis 26 of the bore 23 of the yoke 21 of the second element 2.

In a fifth step of the method, as illustrated in FIG. 7, the pivot shaft 3 is positioned and held in position in the bores 13, 23 of the yokes 11, 21 of the two elements 1, 2 to assemble and hold together the two elements and to provide an articulated joint.

The pivot shaft 3 is a conventional axis, having a cylindrical and circular cross-sectional shape, selected so as to have a diameter which is substantially equal to the inner diameter of the rings 31 and the ball joint 32, and having a sufficient length to go through both yokes 11 of the first element 1 and the yoke 21 of the second element 2.

The pivot shaft 3 is held in a conventional way, for example at one of both ends thereof through a flange, said flange resting on one yoke 11 of the first element 1, and the other end of which is fixed using a screw or a retaining clip.

The invention thus provides a method for assembling two elements through an articulated joint, reinforced at the level of the bores of the various yokes, in order to increase the resistance of said joint to stresses, mainly alternate efforts, without affecting the articulation and preload characteristics of said elements.

1. A method for assembling two non-integral elements to form an articulated mechanical joint, a first element including, at said articulated mechanical joint, an end piece including at least one yoke made of a metallic material, a second element including, at said articulated mechanical joint, at least one yoke made of a metallic material, said method comprising:
a) drilling of bores:
a1) bores in the yoke or yokes of the first element according to nominal dimensions for the mounting of one ring or rings,
a2) bores in the yoke or yokes of the second element according to nominal dimensions for mounting a ball joint or ball joints,
b) snug fit assembly:
b1) of one ring or rings on an inner surface of the bore of the yoke or yokes of the first element,
b2) of one ball joint or ball joints on an inner surface of the bore of the yoke or yokes of the second element,
c) positioning of the at least two elements of the articulated joint so that the bores of said two elements are coaxial,
d) mounting of a pivot shaft in the ring and ball joint of the bores so that said pivot shaft holds together the at least two previously positioned elements,
wherein the method further comprises shot-peening the inner surfaces of the bores of the yokes of the two elements so as to create a compressive stresses on said inner surfaces of the bores of the yokes of said two elements, said additional step of shot-peening being carried out, for each bore between the step of the drilling of the bore and the step of the interference mounting of the ring or the ball joint.

2. A method according to claim 1, wherein during the shot-peening, a shot-peening is carried out on surfaces of chamfers when the bores of the yokes include one or more chamfers.

3. A method according to claim 1, wherein the shot-peening of the inner surfaces of the bores is carried out using an oscillating shot-peening nozzle, radially projecting shots, and positioned inside said bores.

4. A method according to claim 1, wherein the shot-peening of the inner surfaces of the bores is carried out by a deflector, axially projecting shots, and positioned inside said bores.

5. A method according to claim 1, wherein a reboring of the bore to the nominal dimensions for the assembly is carried out after the shot-peening step.

6. A method according to claim 1, wherein anti-corrosion surface treatments are carried out after the reboring of the bore.

7. A mechanical joint comprising a first element comprising at least one yoke, made of a metallic material, and a second element comprising at least one yoke, made of a metallic material, each yoke comprising a bore said bores comprising chamfers and being coaxial so as to insert a pivot shaft for the two elements assembly, wherein the material of the yokes is permanently subjected to a compressive stress below the inner surfaces of the bores including in the chamfer area and independently from the snug fit assembly of the ring or the ball joint in said bores.
